(19) United States
(12) Patent Application Publication
(10) Pub. No.: US 2005/0072287 A1
(43) Pub. Date: Apr. 7, 2005

(54) Pierce cam

(76) Inventor: Noritoshi Kitamura, (US)

Correspondence Address: BIRCH STEWART KOLASCH & BIRCH, PO BOX 747, FALLS CHURCH, VA, 22040-0747, US

(21) Appl. No.: 10/885,692

(22) Filed: Jul. 8, 2004

(30) Foreign Application Priority Data
Oct. 2, 2003 (JP) 2003-344676

(51) Int. Cl. B26F 1/14

(52) U.S. Cl. 83/549; 83/618; 83/684

(57) ABSTRACT

An object of the invention is to provide a pierce cam which is compact, can save space, can be easily mounted, can reduce a cost, and can be mounted even to a slope surface, and in which a pierce punch and required accessories can be ordered in a lump. The invention provides a pierce cam comprising a pierce punch, a body which is detachably provided with the pierce punch, a stripper which is inward fitted to a leading end portion of the pierce punch and is energized by a coil spring, a rotating arm which is swingably provided in the body and is brought into contact with a rear end surface of the pierce punch, and a driver which transfers a descending force of a press machine to the rotating arm, and hooks and ascends the rotating arm at the time of moving upward.

### BACKGROUND OF THE INVENTION

The present invention relates to a pierce cam, and more particularly to a standardized piece cam.

A conventional pierce cam is constituted, as shown in FIG. 16, by a pierce punch 101, a punch plate 102 which holds the pierce punch 101, a stripper 103 which presses a work W before piercing by the pierce punch 101 and takes away the pierce punch 101 from the work W after piercing, a cushion rubber (there is a case of a coil spring) 104 which presses the stripper 103, a passive cam 105 which mounts the punch plate 102 thereto and moves backward and forward toward the work W, an actuating cam 106 which moves forward the passive cam 105, a base plate block 107 which slides and holds the passive cam 105, and serves as a heel in the case that the actuating cam 106 drives the passive cam 105, and a coil spring 108 which returns the passive cam 105.

The passive cam 105, the actuating cam 106 and the base plate block 107 are made of cast metal, require a wide space and are expensive.

As mentioned above, the conventional pierce cam is large-scaled, requires a lot of space, is hard to be mounted, is expensive, and is hard to be mounted to a slope surface.

Further, since the pierce punch 101, the passive cam 105, the actuating cam 106 and the base plate block 107 are generally ordered from different makers, it is impossible to order in a lump and it is inconvenient in view of production control.

An object of the present invention is to provide a pierce cam which is compact, can save space, can be easily mounted, can reduce a cost, and can be mounted even to a slope surface, and in which a pierce punch and required accessories can be ordered in a lump.

Taking the matters mentioned above into consideration, in order to make it possible to make the structure compact, save space, be easily mounted, reduce a cost, be mounted to a slope surface and order a pierce punch and required accessories in a lump, in accordance with the present invention, there is provided a pierce cam comprising a pierce punch, a body which is detachably provided with the pierce punch, a stripper which is inward fitted to a leading end portion of the pierce punch and is energized by a coil spring, a rotating arm which is swingably provided in the body and is brought into contact with a rear end surface of the pierce punch, and a driver which transfers a descending force of a press machine to the rotating arm, and hooks and ascends the rotating arm at the time of moving upward.

### BRIEF DESCRIPTION OF THE DRAWINGS

FIG. 1 is a front elevational view of a pierce cam in accordance with a specific embodiment of the present invention;

FIG. 2 is a plan view excluding a driver;

FIG. 3 is a front elevational view of a body;

FIG. 4 is a side elevational view of the body;

FIG. 5 is a plan view of the body;

FIG. 6 is a front elevational view of a pierce punch;

FIG. 7 is a side elevational view of the pierce punch;

FIG. 8 is a plan view of the pierce punch;

FIG. 9 is a front elevational view of a stripper;

FIG. 10 is a plan view of the stripper;

FIG. 11 is a front elevational view of an oscillating arm;

FIG. 12 is a front elevational view of a slide pin;

FIG. 13 is a plan view of the slide pin;

FIG. 14 is a front elevational view of the present pierce cam in a state in which the driver is moved upward;

FIG. 15 is a front elevational view of a state in which the present pierce cam is mounted to a slope surface; and

FIG. 16 is a vertical cross sectional view of a conventional pierce cam.

### EMBODIMENT

A detailed description of the present invention will be given below on the basis of a specific embodiment shown in the accompanying drawings.

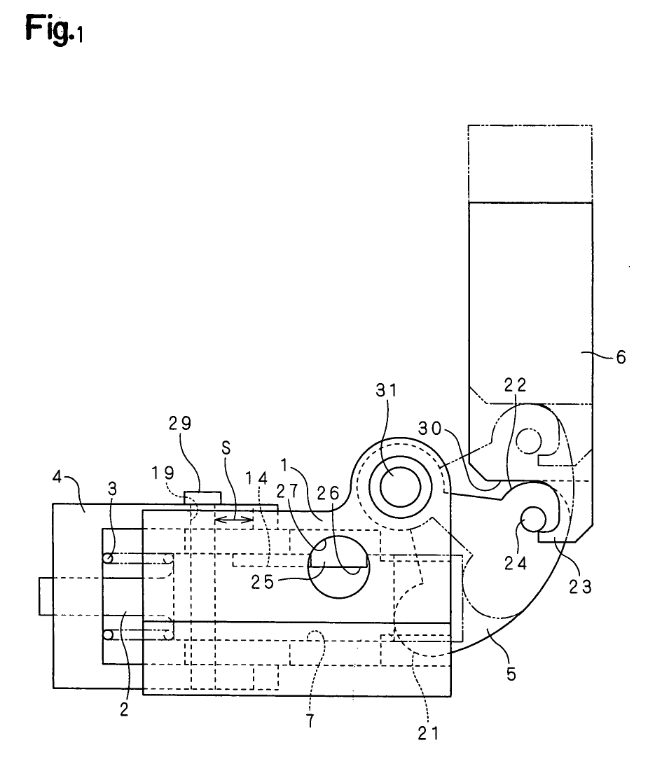

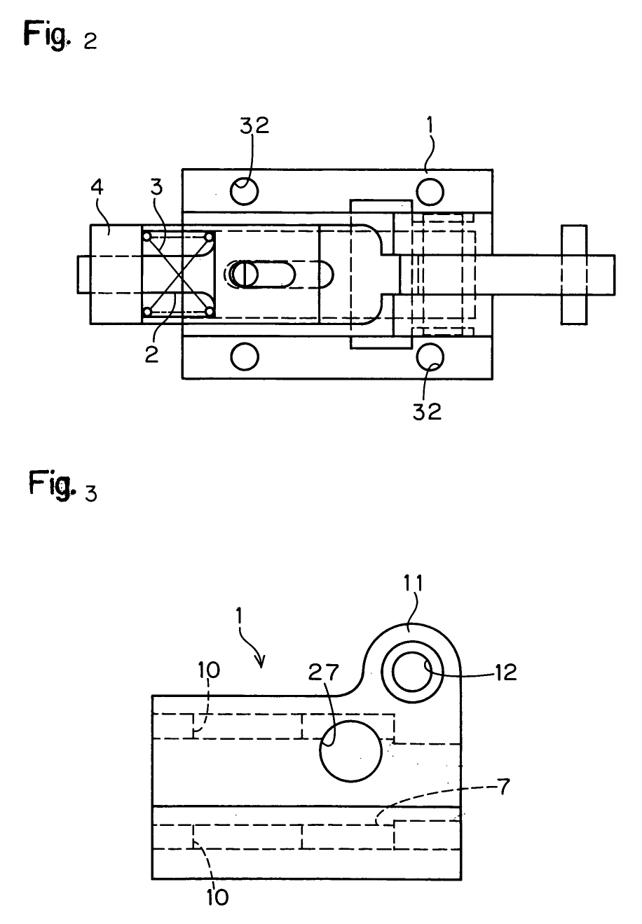

FIG. 1 is a front elevational view of a pierce cam in accordance with a specific embodiment of the present invention, and FIG. 2 is a plan view excluding a driver.

A pierce punch 2 is detachably provided in a body 1, a stripper 4 energized by a coil spring 3 is slidably provided in the body 1, an oscillating arm 5 is swingably pivoted to the body 1, a lower portion of the oscillating arm 5 is brought into contact with a rear end surface of the pierce punch 2, and a driver 6 provided in a trailing manner in an upper die transfers a downward moving force of a press machine to the oscillating arm 5, and hooks the rotating arm 5 at the time of moving upward.

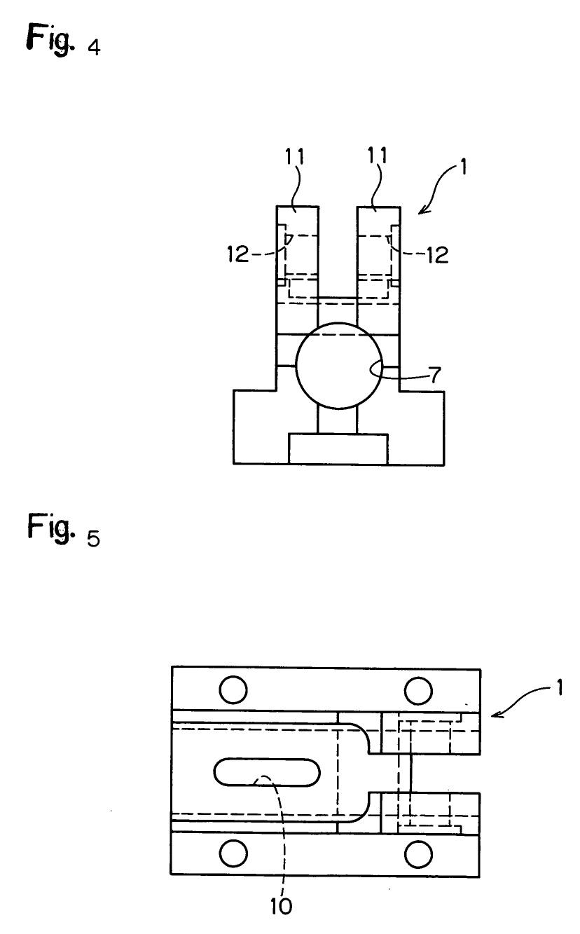

Details of the body 1 will be shown in FIGS. 3 to 5. FIG. 3 is a front elevational view of the body 1, FIG. 4 is a side elevational view of the same and FIG. 5 is a plan view of the same.

A guiding hole 7 for attaching and detaching the pierce punch 2 is pierced in the body 1.

At the time of piercing by the pierce punch 2, a long hole 10 for mounting a stripper 4 which serves to press the work before piercing and take away the pierce punch 2 from the work after piercing is pierced in the body 1.

A bracket portion 11 provided with the oscillating arm 5 is pierced in an upper portion of a rear end of the body 1, and a mounting hole 12 is pierced in the bracket portion 11.

In this case, reference numeral 32 denotes a mounting hole for mounting to a lower die main body.

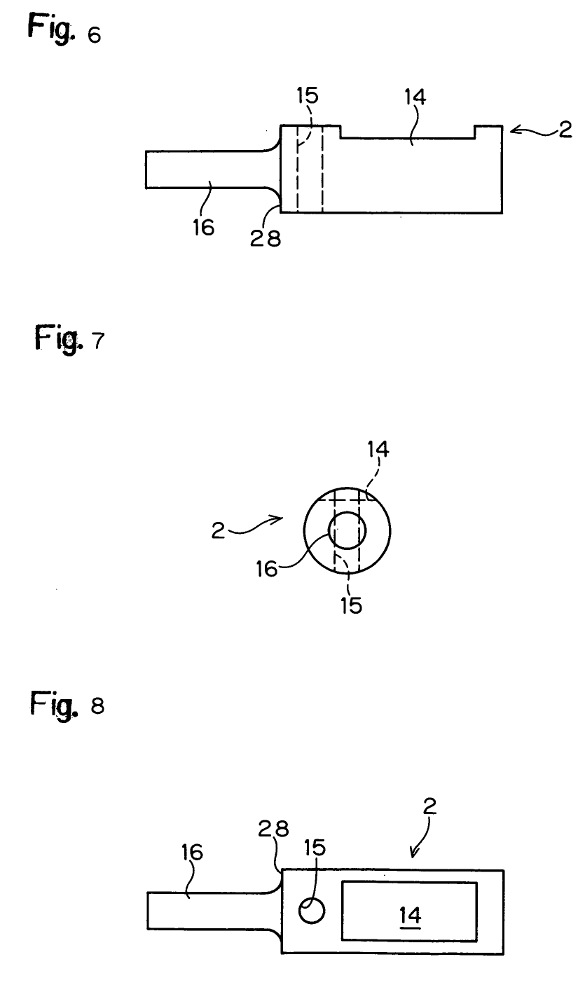

Details of the pierce punch 2 will be shown in FIGS. 6 to 8. FIG. 6 is a front elevational view of the pierce punch 2, FIG. 7 is a side elevational view of the same and FIG. 8 is a plan view of the same.

The pierce punch 2 is structured such that a shaft portion 13 is formed into a circular shape so as to be attached to the guiding hole 7 of the body 1, and a flat surface 14 is formed in an intermediate portion of the shaft portion 13 so as to bring the piece punch 2 into contact with a stopper surface 9 for fixing. Further, a positioning hole 15 is pierced in a front end portion of the shaft portion 13.

A seat portion 28 of the coil spring 3 is formed in a front end surface of the shaft portion 13 in accordance with a cutting operation.

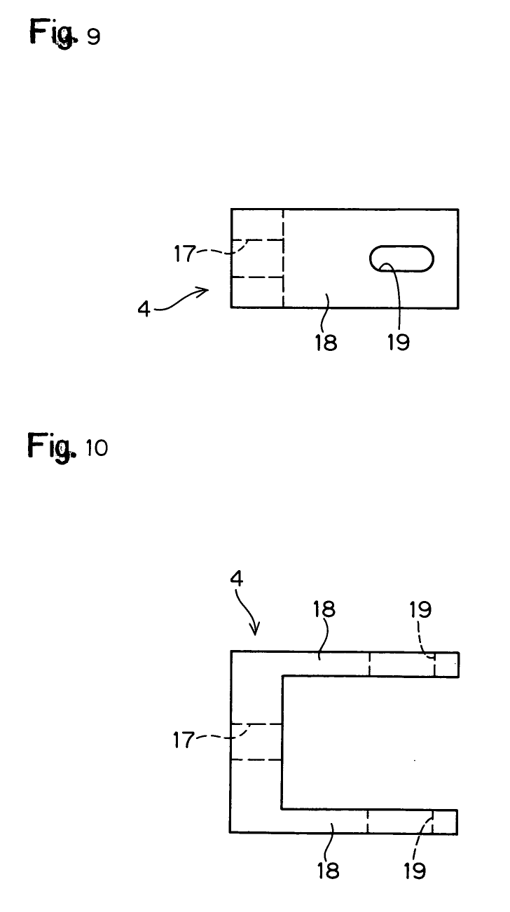

Details of the stripper 4 will be shown in FIGS. 9 and 10. FIG. 9 is a front elevational view of the stripper 4 and FIG. 10 is a plan view of the same.

The stripper 4 is constituted by a copper casted product, and is formed in a C-shaped cross section, and an inner surface of a hole 17 to which a hole forming portion 16 of the pierce punch 2 is fitted is impregnated with a graphite such that the hole forming portion 16 of the pierce punch 2 can smoothly move.

A stroke length hole 19 for determining a stroke of the stripper 4 is pierced in both side walls 18 of the stripper 4.

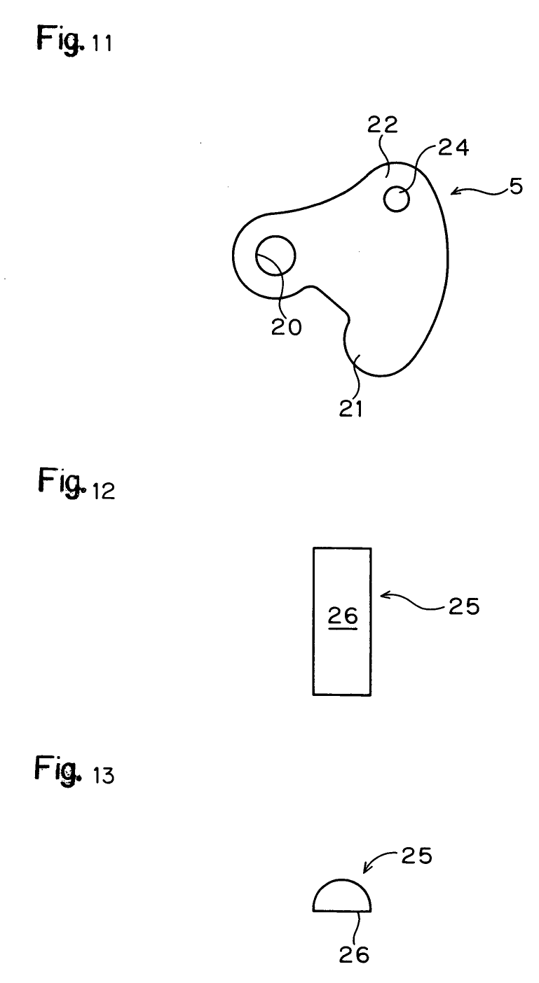

Details of the oscillating arm 5 will be shown in FIG. 11. The oscillating arm 5 is constituted by a fan-shaped plate-like body, a hole 20 is pierced in a center of oscillation, one end portion is formed in a circular arc contact portion 21 which is brought into contact with the rear end surface of the pierce punch 2, and another end portion is formed in a circular arc contact portion 22 which is brought into contact with the driver 6, respectively. Further, a pin 24 with which a hook 23 of the driver 6 is caught at a time of moving upward is provided in another end portion so as to protrude to both sides.

A slide pin 25 will be shown in FIGS. 12 and 13. FIG. 12 is a front elevational view of the slide pin 25, and FIG. 13 is a plan view of the same. The slide pin is used for attaching and detaching the pierce punch 2 to and from the body 1, and is formed by separating a circular column body into half and slightly cutting both sides of a flat surface 26.

The present pierce cam is assembled as follows.

The pierce cam is assembled by inserting the pierce punch 2 to the guiding hole 7 of the body 1, bringing the rear end surface thereof into contact with the stopper surface 9, bringing the flat surface 26 of the slide pin 25 into contact with the flat surface 14 of the pierce punch 2 so as to insert to an attaching and detaching hole 27 of the body 1, and fixing the pierce punch 2. In the case that it is necessary to replace the pierce punch 2 due to a nicked edge or the like, the slide pin 25 is taken out, the pierce pin 2 is replaced by a new pierce punch 2, and the slide pin 25 is inserted and fixed.

The slide pin 25 serves as a rotation prevention of the pierce punch 2 in the case that the hole forming of the pierce punch 2 is the other shapes than a circular shape, for example, a rectangular shape, a hexagonal shape and the like.

Next, the coil spring 3 is seated on a seat portion 28 of the pierce punch 2, the hole forming portion 16 of the pierce punch 2 is fitted to the hole 17 of the stripper 4, and a stopper pin 29 is fitted to the stroke length hole 19 in the side wall 18 of the stripper 14 and the long hole 10 of the body 1. Since the stripper 4 is energized by the coil spring 3, the stripper 4 moves forward by a stroke S.

The oscillating arm 5 is pivoted by a pin 31 while the hole 20 thereof is brought into line with the mounting hole 12 in the bracket 11 of the body 11, the circular arc contact portion 21 thereof is brought into contact with the rear end surface of the pierce punch 2, and the pierce punch 2 and the oscillating arm 5 are pin connected (not shown) by a link.

A lower end surface 30 of the driver 6 firmly fixed to the upper die is brought into contact with the circular arc contact portion 22 of the oscillating arm 5, the oscillating arm 5 is rotated on the basis of the downward movement of the driver 6, and the circular arc contact portion 21 presses the rear end surface of the pierce punch 2 so as to push out the pierce punch 2 forward against an energizing force of the coil spring 3.

After the piercing process by the pierce punch 2, the upper die moves upward, the hook 23 of the driver 6 catches the pin 24 of the oscillating arm 5, rotates the oscillating arm 5 rearward and slides the flat surface 14 of the pierce punch 2 along the flat surface 26 of the slide pin 25, and the pierce punch 2 is returned backward.

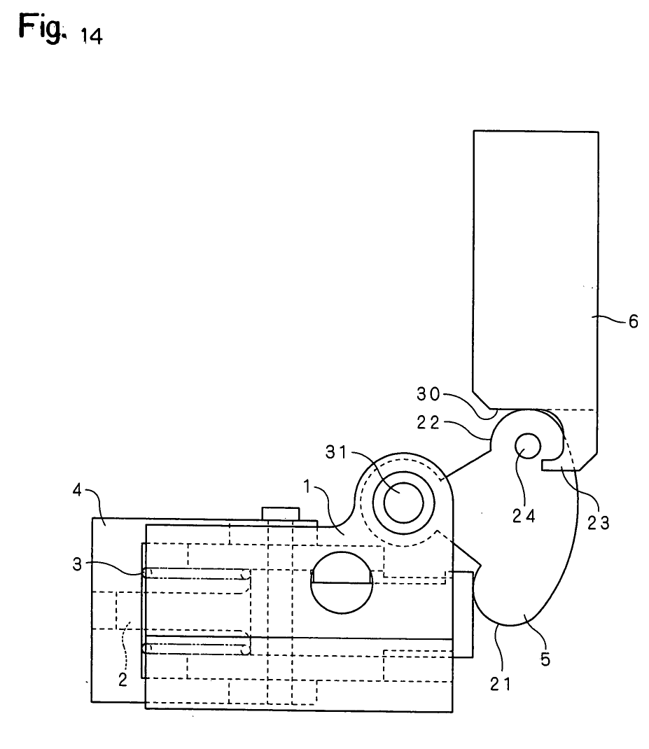

FIG. 14 shows a state in which the driver 6 is moved upward.

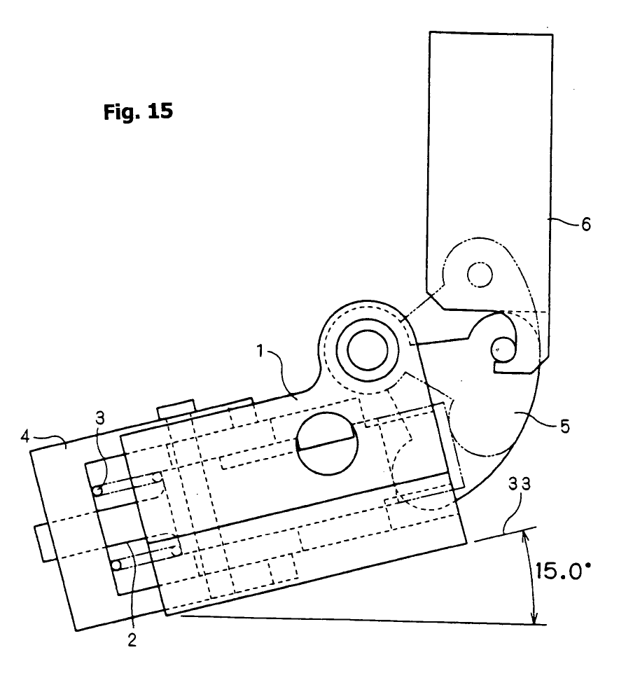

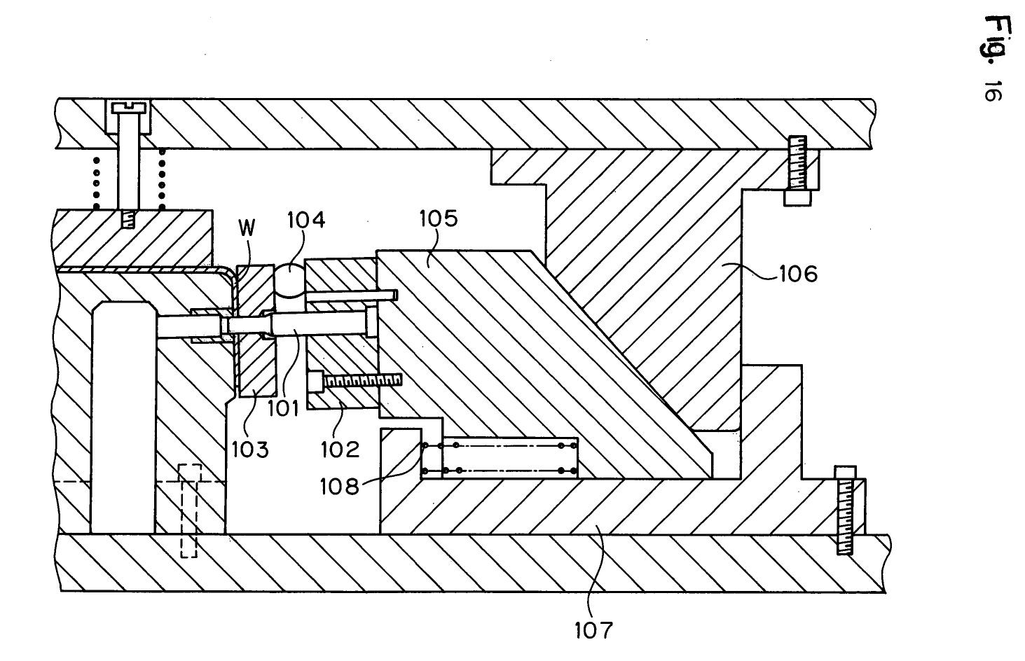

The present pierce cam can be easily mounted even in the case that the mounting surface is even a slope surface 33 as shown in FIG. 15.

The piercing process by the present pierce cam can be easily applied to the structure having a hole diameter of 15 to 35 mm.

The present pierce cam can be utilized for piercing the thin plate formed product, however, can be utilized for piercing a plastic or the like in addition to the thin plate formed product.

Since the present invention provides the pierce cam comprising the pierce punch, the body which is detachably provided with the pierce punch, the stripper which is inward fitted to the leading end portion of the pierce punch and is energized by the coil spring, the rotating arm which is swingably provided in the body and is brought into contact with the rear end surface of the pierce punch, and the driver which transfers the descending force of the press machine to the rotating arm, and hooks and ascends the rotating arm at the time of moving upward, as mentioned above, it is possible to make the structure compact, save space, be easily mounted, reduce a cost, be mounted to the slope surface and order the pierce punch and required accessories in a lump.

1. A pierce cam comprising:
a pierce punch;
a body which is detachably provided with the pierce punch;
a stripper which is inward fitted to a leading end portion of the pierce punch and is energized by a coil spring;
a rotating arm which is swingably provided in the body and is brought into contact with a rear end surface of the pierce punch; and
a driver which transfers a descending force of a press machine to the rotating arm, and hooks and ascends the rotating arm at a time of moving upward.
